(19) United States
(12) Patent Application Publication
(10) Pub. No.: US 2024/0322936 A1
(43) Pub. Date: Sep. 26, 2024

(54) Electronic portion of a CRPA antenna of an anti-jamming device for a GNSS receiver and associated anti-jamming device and method for processing signals

(71) Applicant: THALES, Meudon (FR)

(72) Inventors: Nicolas MARTIN, VALENCE CEDEX (FR); Christian MEHLEN, VALENCE (FR); David DEPRAZ, VALENCE (FR)

(21) Appl. No.: 18/579,897

(22) PCT Filed: Jul. 21, 2022
(86) PCT No.: PCT/EP2022/070479

§ 371 Date: Jan. 17, 2024

(30) Foreign Application Priority Data
Jul. 22, 2021 (FR) FR2107910

(51) Int. Cl. H04K 3/00

(52) U.S. Cl. CPC H04K 3/25

(57) ABSTRACT

An electronic portion of a CRPA antenna of an anti-jamming device for a GNSS receiver, including M elementary signal inputs, for each input, a bandpass filter bank which is configured to break down each elementary signal received by this input at a frequency Fe, into P sub-bands to obtain P sub-sampled signals at a frequency Fe/P, a calculational component which is configured to apply in parallel anti-jamming processing at the frequency Fe/P to the sub-sampled signals, to obtain a cleaned sub-sampled signal, and a summation component which is configured to receive all the cleaned sub-sampled signals and to form, from these sub-sampled signals a resulting corresponding cleaned signal at the frequency Fe.

### CROSS-REFERENCE TO RELATED APPLICATIONS

This application claims benefit under 35 USC § 371 of PCT Application No. PCT/EP2022/070479 entitled ELECTRONIC PORTION OF A CRPA ANTENNA OF AN ANTI-JAMMING DEVICE FOR A GNSS RECEIVER, AND ASSOCIATED ANTI-JAMMING DEVICE AND METHOD FOR PROCESSING SIGNALS, filed on Jul. 21, 2022 by inventors Nicolas Martin, Christian Mehlen and David Depraz. PCT Application No. PCT/EP2022/070479 claims priority of French Patent Application No. 21 07910, filed on Jul. 22, 2021.

### FIELD OF THE INVENTION

The present invention relates to an electronic portion of a CRPA antenna of an anti-jamming device for a GNSS receiver.

The present invention further relates to an anti-jamming device for a GNSS receiver and associated method for processing signals.

More particularly, the technical field of the invention is the field of anti-jamming devices based on controlled pattern antenna networks for GNSS (Global Navigation Satellite System) receivers. This type of antenna is also known by the English acronym CRPA (Controlled Radiated Pattern Antenna).

### BACKGROUND OF THE INVENTION

An anti-jamming device generally consists of an antenna array, cables and an electronic part of an CRPA antenna. Such a device is configured to provide a GNSS signal that is partially or totally devoid of interfering signals initially present in the effective band of the satellite signals. As a result, the GNSS receiver connected to the output of such an anti-jamming device can properly operate and provide a navigation solution. The GNSS signals are in the L1, E6, L2 and E5 bands with widths comprised between 40 MHz and 20 MHz.

In a way known per se, the electronic part of the CRPA antenna uses a plurality of types of algorithms for attenuating the interference while preserving the effective GNSS signals. The choice of an algorithm is a compromise between performance and complexity. Performance is characterized in terms of interference attenuation, convergence time and delay on the signal. Complexity reflects on development cost, recurring cost, and power consumption (and hence thermal problem).

The general principle of the processing performed by the electronic part consists in carrying out a linear combination with complex coefficients of the signals received on each of the input channels brought to baseband and digitized (complex signal samples).

There is a plurality of types of treatments:
SAP (Space Adaptive Processing), purely spatial, wherein a linear combination of N=M signals received in the entire sampled band [−Fe/2, +Fe/2] is performed on M antennas;
Space time Adaptive Processing (STAP), wherein a linear combination of N=M×L signals received in the entire band sampled on M antennas is performed, creating L time-shifted versions (with between 0 and L−1 delays of one sampling period) on each antenna;
Space Frequency Adaptive Processing (SFAP), wherein an SAP is performed in P sub-bands obtained by means of a digital filter bank, before summing the P filtered signals.

The most efficient methods of processing are STAP and SFAP, but same require significantly more calculations, in particular for obtaining the complex weights.

The problem is to find a way to calculate the complex weighting coefficients, that is fast in real-time, efficient and inexpensive.

There are two families of algorithms for the calculation of the complex weights of the linear combination:
The so-called “direct inversion” algorithms which consist in calculating the complex coefficients of the linear combination from the cross-correlation matrix Rxx of the N received signals, at the end of each period of calculation of Rxx, by integration of the N×N complex crossed products of the N signals received over a time interval (hence with a frequency slower than the sampling frequency);
the so-called “iterative” algorithms that progressively update the complex coefficients directly from the samples of the received signals, each time new samples are available (hence at the sampling frequency).

The family of iterative algorithms includes the so-called LMS (Least Mean Square) method and the so-called RLS (Recursive Least Square) method. The LMS method is sub-optimal and seeks to minimize the output power by the gradient method with a non-instantaneous convergence. The RLS method is optimal and directly calculates the optimal coefficients that minimize the output power. Same requires many more calculations.

Direct inversion algorithms make it possible to obtain the best possible performance in the case where the jammers are substantially stationary. Moreover, in such case, the calculations to be made in the hardware are simple. However, the algorithms also require computations in software because same require floating-point operations. The speed of the calculations is thus limited by the performance of the processors implementing the calculations. The performance may be insufficient in the case of non-stationary (pulsed) jammers which require a short response time. The above also limits the number M of channels of the antenna array and the number of delays L of the STAP, since the number of operations to be performed for calculating the complex weights is proportional to the cube of N=M×L. Furthermore, if it is desired to obtain optimum performance for interference attenuation, it is necessary to apply a delay to the signal received on each input channel, equivalent to the time required to perform the calculation of the Rxx matrix and the calculation of complex weight coefficients. In this way it is possible to apply the complex weights to the received signal samples that were used to calculate same via the Rxx matrix, and thereby maintain consistency, when the jamming fluctuates over time. However, the delay induced on the output signal could be detrimental to the downstream receiver, the role of which is also to provide a precise time measured from the GNSS signals, since same will lead to a bias on the resolved time.

The LMS method has the advantage of being very simple since same requires very few calculations at each step and is thus feasible on a purely hardware component (such as an FPGA), without any significant delay on the received signals. On the other hand, the method requires a convergence time that can be very long (up to 10 milliseconds) to achieve the same gain performance as direct inversion algorithms. In the presence of non-stationary interference, the above can be penalizing.

The RLS method requires significantly more calculations but has a very fast convergence time (a few micro-seconds). However, in the case of a STAP, the method is not feasible with the current technologies on a purely hardware component. Indeed, in such a case, the number of calculations to be performed at each sampling period of the received signal, proportional to N²=(M×L)², is very large, which leads to an excessive number of multipliers. In the case of a purely spatial SAP, it would be possible to ensure the hardware resources for performing the calculations, but it is the clock frequency that would be incompatible with too many calculation steps to be performed at each sampling period.

### SUMMARY OF THE DESCRIPTION

The goal of the present invention is to overcome such drawbacks and to propose a way of calculating the complex weighting coefficients which can be performed on a purely hardware component in a way that is at the same time fast, efficient and inexpensive.

To this end, the invention relates to an electronic part of the CRPA antenna of an anti-jamming device for a GNSS receiver, comprising:
M inputs configured to receive elementary signals in B frequency bands; coming from an array antenna comprising M elementary antennas;
for each input and each frequency band, a bandpass filter bank configured to decompose each elementary signal received by the input in the band at a frequency Fe, into P sub-bands for obtaining P sub-sampled signals at a frequency Fe/P;
a calculation component configured to apply, in each sub-band in parallel, an anti-jamming processing at the frequency Fe/P to the sub-sampled signals coming from the M inputs, so as to obtain a cleaned sub-sampled signal, the calculation component having a single hardware component for all sub-bands of all bands, operating at the frequency B.Fe;
a summation component configured to receive all the cleaned sub-sampled signals of the same frequency band and to form from the sub-sampled signals a resulting corresponding cleaned signal, at the frequency Fe.

According to other advantageous aspects of the invention, the electronic part comprises one or a plurality of the following features, taken individually or according to all technically possible combinations:
the calculation component comprises B.P calculation layers configured to implement an iterative processing, each calculation layer operating at the frequency B.Fe and being apt to implement a step of said iterative processing or a delay step;

The calculation layers being consecutive from a layer number 1 to layer number B.P;
the layer number 1 being apt to of receive at each period B.Fe, the M sub-sampled signals of the same sub-band and an iterative datum coming from the layer number B.P at the previous period B.Fe;
said iterative processing being the recursive least squares method;
said iterative datum being the symmetric complex covariance matrix Pₙ of dimensions M×M, corresponding to the inverse of the cross-correlation matrix Rₓₓ of the corresponding M sub-sampled signals;
said iterative processing comprising:
   a first step including the calculation of the complex vector:

$$PH t = {P}_{n} \cdot {h}_{n + 1} * ,$$

where hₙ₊₁ is the complex line vector containing the M sub-sampled signals from the bandpass filter banks corresponding to the current sampling period;
a second step comprising the calculation of the positive real scalar:

$$HPHt = {h}_{n + 1} \cdot PH t ;$$

a third step comprising the calculation of the positive real scalar:

$$D\_inv = 1 / ( 1 + HPHt )$$

a fourth step comprising the calculation of the registration gain vector:

K=PHt.D_inv
a fifth step comprising the calculation of the registered covariance matrix, symmetric complex:

$${P}_{n + 1}^{′} = {P}_{n} - K \cdot PHt *$$

a sixth step comprising the calculation of the propagated covariance matrix with a symmetric complex forgetting factor:

$${P}_{n + 1} = {P}_{n + 1}^{′} + 1 / {2}^{n} \cdot {P}_{n + 1}^{′}$$

each cleaned sub-sampled signal being one of the components of the corresponding complex vector PHt;
each cleaned sub-sampled signal being one of the components of the complex vector Pₙ₊₁, Hₙ₊₁* equal to the product of the propagated covariance matrix Pₙ₊₁ by the conjugate transpose of the complex line vector H;
the bandpass filter banks being produced according to the polyphase filter technique;
the summation component comprising a summing interpolating filter adding the cleaned sub-sampled signals;
said interpolator filter being produced according to the technique of polyphase filters;
the calculation component being an FPGA logic circuit.

A further subject matter of invention is an anti-jamming device for a GNSS receiver, comprising:
a CRPA antenna;
an electronic part as described hereinabove.

A further subject matter of the invention is a method for processing signals by an electronic part of a CRPA antenna of an anti-jamming device for a GNSS receiver, comprising the following steps:
receiving on M inputs elementary signals in B frequency bands from an array antenna comprising M elementary antennas;
for each input and each frequency band, decomposing each elementary signal received by the input in said band at a frequency Fe, into P sub-bands, so as to obtain P sub-sampled signals at a frequency Fe/P;
for applying in each sub-band in parallel, an anti-jamming treatment at the frequency Fe/P, to the sub-sampled signals coming from the M inputs, so as to obtain a cleaned sub-sampled signal;
receiving all the cleaned sub-sampled signals of the same frequency band and forming from the sub-sampled signals, a corresponding cleaned signal, at the frequency Fe.

### BRIEF DESCRIPTION OF THE DRAWINGS

The features and advantages of the invention will appear upon reading the following description, given as an example, but not limited to, and making reference to the enclosed drawings, wherein:

FIG. 1 is a schematic view of an anti-jamming device comprising in particular an electronic part of a CRPA antenna;

FIG. 2 is a detailed schematic view of a processing module belonging to the electronic part of the CRPA antenna shown in FIG. 1, according to a generic example of the embodiment of the module;

FIG. 3 is a view similar to the view shown in FIG. 2, the processing module being according to a particular example embodiment of the module.

FIG. 4 is a schematic view illustrating the structure and the operation of a calculation component belonging to the processing module shown in FIG. 3;

FIG. 5 is a schematic view illustrating the operation of a calculation component belonging to the processing module shown in FIG. 2 or FIG. 3.

### DETAILED DESCRIPTION OF EMBODIMENTS

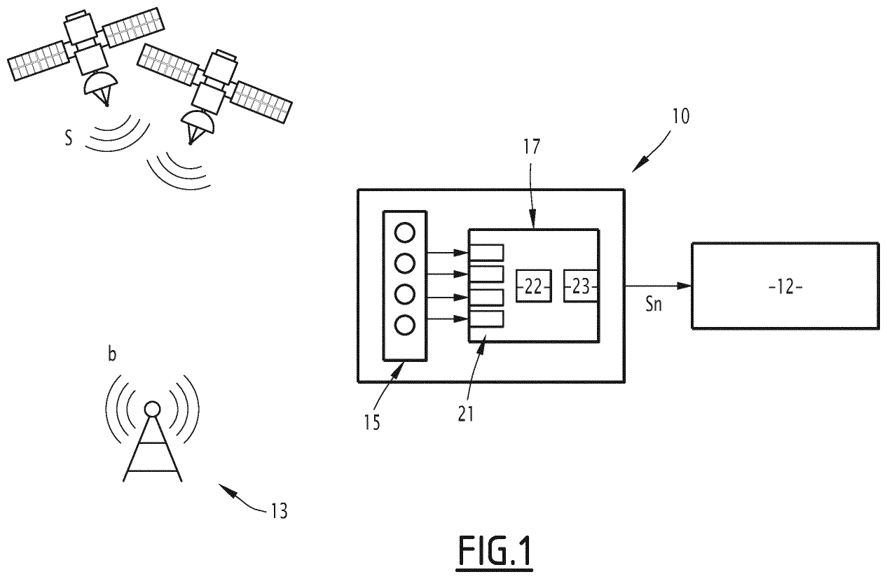

FIG. 1 illustrates an anti-jamming device 10 for a GNSS receiver 12.

The GNSS receiver 12 has a known GNSS signal receiver apt to determine a navigation solution from the received GNSS signals, which come from one or a plurality of satellite navigation systems (such as the GPS system or the GALILEO system). In a way known per se, each satellite navigation system forms a constellation of satellites and is apt to provide one or a plurality of navigation services. For example, the GPS system provides different navigation services, such as e.g. PPS or “code M” services. The same applies to the GALILEO system, which provides e.g. PRS and OS services.

In order to receive GNSS signals, the GNSS receiver 12 is connected to the anti-jamming device 10 used for receiving all the radio frequency signals S available in a given frequency range, and to extract GNSS radio frequency signals therefrom, denoted by “Sn” in FIG. 1, by cleaning same from the jamming radiofrequency signals, denoted by “b” in FIG. 1. The radio-frequency interference signals b come e.g. from one and a plurality of interference sources 13 arranged in the vicinity of the GNSS receiver 12. The sources of interference 13 may be brought in intentionally or unintentionally.

To this end, the anti-jamming device 10 comprises an antenna array 15, also called the CRPA antenna, and an electronic part of the CRPA antenna 17, referred to hereinafter simply by the term “electronic part 17.” The antenna array 15 is apt to receive an input signal on each channel and to transmit the input signals to the electronic part 17.

The antenna array 15 comprises M elementary antennas arranged on a base according to a known configuration. In the example shown in FIG. 1, the number M is equal to 4. Each elementary antenna is connected to the electronic part 17 and is apt to deliver to the part 17, received radiofrequency signals, hereinafter called elementary signals. The input signal Se delivered to the electronic part 17 by the antenna array 15 is thus composed of M elementary signals.

As can be seen in FIG. 1, the electronic part 17 comprises M inputs 21 configured to receive elementary signals coming from the antenna array 15, a processing module 22 configured to process the elementary signals received for generating a cleaned output signal Sn, and an output 23 configured to deliver the cleaned output signal Sn.

More particularly, in the example shown in FIG. 1, each input 21 is connected to one of the elementary antennas of the antenna array 15 and supplies to the processing module 22, digitized elementary input signals, brought to baseband and sampled at the frequency Fe, represented by complex numbers. Furthermore, in the example of the same FIG. 1, the output 23 of the electronic part 17 is connected to the GNSS receiver 12. In such case, the output 23 thus supplies the cleaned output signal Sn, after analog conversion and translation into carrier frequency, to the GNSS receiver 12 which deduces therefrom a navigation solution.

The processing module 22 is apt to process the received radiofrequency signals in order to extract GNSS radiofrequency signals, totally or at least partially free from the jamming radiofrequency signals. More particularly, the processing module 22 is apt to receive the elementary signals received by the antenna array 15 with a sampling frequency Fe which is comprised e.g. between 20 MHz and 80 MHz, and advantageously equal e.g. to 50 MHz. Advantageously, the processing module 22 is apt to process the received radiofrequency signals corresponding to B GNSS bands such as e.g. the bands L1, E6 and L2.

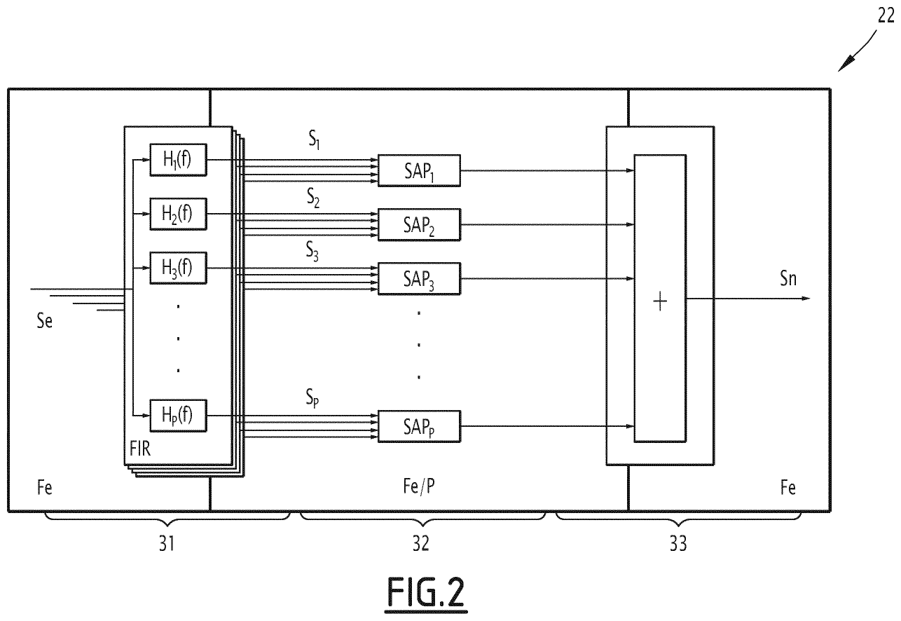

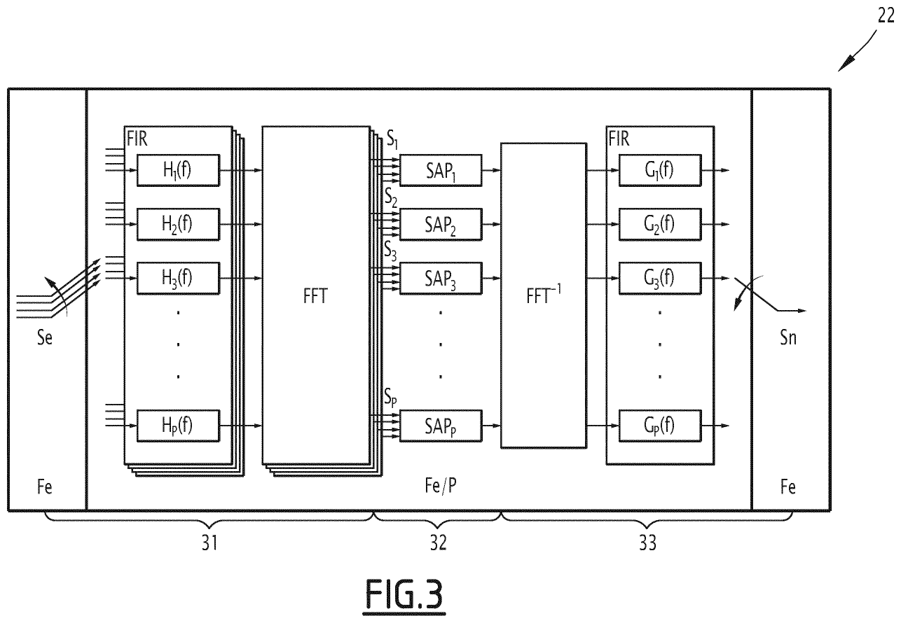

The processing module 22 is illustrated in greater detail in FIG. 2 illustrating an example of generic embodiment of the module and in FIG. 3 illustrating a more particular example of embodiment of the module. Thereby, as can be seen in said figures, the interaction module 22 comprises a filtering component 31, a calculation component 32 and a summation component 33.

The filtering component 31 comprises M banks of sub-sampling bandpass filters. The filtering component 31 thus makes it possible to perform SFAP, as explained hereinabove.

Each bank of filters is connected to one of the M inputs 21 and is apt to receive each elementary signal, digitized and brought to baseband, coming from the input in order to decompose same into P sub-bands, i.e. in order to obtain P sub-sampled signals S₁, . . . , S_{P}. Advantageously, the number P is equal to a power of 2 and preferentially can be chosen to be equal to 8 or 16.

Advantageously, according to the particular embodiment shown in FIG. 3, each bank of filters is implemented according to the technique known as “polyphase filters”. The above means that instead of using P bandpass filters in parallel working at the frequency Fe, the sampling frequency of each sub-band being reduced by the factor P, as a result, the filter bank can be produced with a single multiplexed FIR filter (working at the frequency Fe) having a number of coefficients reduced by the factor P. The FIR filter (Finite Impulse Response Filter) is known per se. Furthermore, in the particular embodiment illustrated in FIG. 3, the P outputs of the multiplexed FIR filter produced at the frequency Fe/P are connected to an FFT (Fast Fourier Transform) operator for performing a fast Fourier transform of the vector consisting of the P outputs and to find at the output, the equivalent of a sub-sampled digital filter bank.

The calculation component 32 makes it possible to process all the sub-sampled signals S₁, . . . , S_{P} formed by the M filter banks by applying one of the methods for calculating the complex weighting coefficients corresponding to the sub-sampled signals.

To this end, the calculation component 32 comprises a clock and P consecutive calculation layers from a layer number 1 to a layer number P. The calculation component 32 is apt to perform, at each clock cycle, a calculation operation in each of the P calculation layers and to transmit the result of the operations to the following layers.

Furthermore, at each clock cycle, the layer number 1 is apt to receive a next sub-sampled signal Sᵢ from the sub-band number i coming from the filtering component 31 and a next iterative datum Pₙᵢ coming from the layer number P at the previous clock cycle. Furthermore, the layer number P was apt to supply the previous clock cycle with the output signal SAPᵢ from the sub-band number i, said next iterative datum Pₙᵢ and said output signal being calculated by previous calculation layers during the previous clock cycles from a previous iterative datum Pₙ₋₁ᵢ and a previous sub-sampled signal Sᵢ. The output signals SAPᵢ thus correspond to the sub-sampled signals cleaned by the calculation component 32.

Thereby, the calculation component 32 has a structure apt to implement iterative processing while acquiring at each clock cycle, a new input datum Sᵢ and supplying an output datum SAPᵢ.

The nature of the calculation operations performed in each of the layers as well as the iterative data depend on the calculation method chosen. An example of such a method will be explained in more detail thereafter.

Advantageously, according to the invention, the calculation component 32 entirely has a single hardware component, such as a field-programmable gate array (FPGA) logic circuit.

In such a case, the layered architecture of the calculation component 32 as described hereinabove, is known by the term “pipeline” architecture. In such case, also in a way known per se, the consecutive layers are interconnected by flip-flops for the transmission between the layers, of data resynchronized on the clock of the logic circuit.

Furthermore, advantageously, the clock frequency of the calculation component 32 is a multiple of the sampling frequency Fe, which makes it possible to process a plurality of GNSS bands in parallel. According to an example of embodiment, the clock frequency is equal to 2.Fe, for processing two bands when B=2.

When the banks of digital filters 31 are produced according to the technique of polyphase filters, the summation component 33 comprises an operator FFT⁻¹ (visible in the embodiment shown in FIG. 3) for performing an inverse Fast Fourier Transform of the vector consisting of the P output signals SAP₁, . . . , SAP_{P}, and an interpolator summing filter adding the signals SAP₁, . . . , SAP_{P}, such as a multiplexed FIR filter, used for supplying a cleaned output signal Sn at the frequency Fe.

Advantageously, according to the invention, the calculation component 32 is suitable for implementing the RLS method for calculating complex weighting coefficients per sub-band.

More particularly, the method consists in calculating the vector W of the complex weighting coefficients for each sub-band i from 1 to P, using the following formula:

$$W = \frac{{Rxx}^{- 1} \cdot \overline{C}}{{C}^{t} \cdot {Rxx}^{- 1} . \overline{C}} \qquad ( 1 )$$

where
Rxx is a matrix of cross-correlation of the M sub-sampled signals of the sub-band i by the antenna array 15, i.e. Rxx=S̅ₑ̅^̅{̅t̅}̅.̅S̅ₑ̅ where Sₑ is the matrix with n rows and M columns containing n row vectors hₘ (m=1 to n) consisting each of the M signals sub-sampled by the sub-band i at a time t=1 to T; and
C is a vector used for satisfying the constraint on the conservation of GNSS signals: C^{t}.W=1.

In practice, in order not to favor any GNSS direction, the vector C can be chosen as follows:

$$c = [ \begin{matrix}1 \\ 0 \\ ⋮ \\ 0\end{matrix} ] .$$

Formula (1) requires solving at least the following system:

C=Rxx.X

The optimal vector W is given by the following relation:

$$W = \frac{X}{{C}^{t} \cdot X}$$

According to the Recursive Least Square (often replaced by the acronym RLS) method, known per se, it is not necessary to recalculate the inverse of the matrix Rxx for updating the vector w each time a row is added to the matrix Sₑ, which saves calculations.

Indeed, the recursive least squares method makes it possible to calculate the matrix Rxx⁻¹ progressively as the input signal samples become available:

$${R}_{n} = {Rxx}_{n} = \overline{{S}_{e}^{t}} \cdot {S}_{e} = \overline{{H}_{n}^{t}} \cdot {H}_{n}$$

$${H}_{n} = {S}_{e} = [ \begin{matrix}{S}_{e 1} ( ( q + 1 ) \cdot T ) & {S}_{e 2} ( ( q + 1 ) \cdot T ) & & {S}_{e N} ( ( q + 1 ) \cdot T ) \\ {S}_{e 1} ( ( q + 2 ) \cdot T ) & {S}_{e 2} ( ( q + 2 ) \cdot T ) & & {S}_{e N} ( ( q + 2 ) \cdot T ) \\ ⋮ & ⋮ & ⋯ & ⋮ \\ {S}_{e 1} ( ( q + n ) \cdot T ) & {S}_{e 2} ( ( q + n ) \cdot T ) & & {S}_{e N} ( ( q + n ) \cdot T )\end{matrix} ] = [ \begin{matrix}{h}_{0} \\ {h}_{1} \\ ⋮ \\ {h}_{n}\end{matrix} ]$$

It should be noted that:

$${R}_{n + 1} = {R}_{n} + \overline{{h}_{n + 1}^{t}} \cdot {h}_{n + 1}$$

and we demonstrate the following result:

$${R}_{n + 1}^{- 1} = {R}_{n}^{- 1} - {R}_{n}^{- 1} \cdot \overline{{h}_{n + 1}^{t}} \cdot {( 1 + {h}_{n + 1} \cdot {R}_{n}^{- 1} \cdot \overline{{h}_{n + 1}^{t}} )}^{- 1} \cdot {h}_{n + 1} \cdot {R}_{n}^{- 1}$$

Which can be written:

$${R}_{n + 1}^{- 1} = {R}_{n}^{- 1} - {K}_{n + 1} \cdot {h}_{n + 1} \cdot {R}_{n}^{- 1}$$

$$with :$$

$${K}_{n + 1} = {R}_{n - 1}^{- 1} \cdot \overline{{h}_{n}^{t}} \cdot {( 1 + {h}_{n} \cdot {R}_{n - 1}^{- 1} \cdot \overline{{h}_{n}^{t}} )}^{- 1} .$$

Thereby, according to the RLS method, rather than calculating the inverse of the matrix Rxx at each end of the integration interval of Rxx, the inverse Rxxₙ⁻¹ is updated at each sampling period of the received signals.

To obtain the vector of the complex weighting coefficients, we first calculate:

$$X = {R}_{n + 1}^{- 1} \cdot \overline{C}$$

$$Then :$$

$${W}_{n + 1} = \frac{X}{{C}^{t} \cdot X}$$

In the general case where:

$$C = [ \begin{matrix}1 \\ 0 \\ ⋮ \\ 0\end{matrix} ]$$

the vector X is equal to the first column of Rₙ₊₁⁻¹ and the scalar C^{t}.X is equal to the first coefficient of Rₙ₊₁⁻¹.

Furthermore, according to the invention, it is possible to use a forgetting factor in order to limit the equivalent integration time of the cross-correlation matrix Rxx. The forgetting factor can take the following form:

$${R}_{n + 1}^{- 1} , = {e}^{\frac{τ}{T}} \cdot {R}_{n + 1}^{- 1} .$$

It is possible to choose

$${e}^{\frac{τ}{T}}$$

equal to

$$1 + \frac{1}{{2}^{b}}$$

so as to avoid multiplications which are much more expensive than additions and bit shifts, where b is an integer parameterizing the forgetting factor. Thereby, the forgetting factor takes the following form:

$${R}_{n + 1}^{- 1 ′} = {R}_{n + 1}^{- 1} + \frac{1}{{2}^{b}} . {R}_{n + 1}^{- 1}$$

The layers of the calculation component 32 are thus suitable for iteratively calculating the coefficients Wₙ₊₁ while taking into account the forgetting factor. In such case, the iterative data used by said layers correspond to the covariance matrix Pₙ=Rₙ⁻¹, the inverse of the cross-correlation matrix Rxx=Rₙ.

The iterative processing of the matrix Pₙ can be carried out in the following six consecutive steps:
a first step including the calculation of the complex vector.

$$PHt = {P}_{n} . {h}_{n + 1}^{*}$$

where hₙ₊₁ is the complex line vector containing the M sub-sampled signals at the frequency Fe/P at the output of the digital filter of the sub-band processed by the layer carrying out the step and “*” denotes the transposed conjugate vector;
a second step comprising the calculation of the positive real scalar

$$HPHt = {h}_{n + 1} . PHt$$

a third step comprising the calculation of the positive real scalar;

$$D\_inv = 1 / ( 1 + HPHt )$$

a fourth step comprising the calculation of the registration gain, complex vector

K=PHt. D_inv
a fifth step comprising the calculation of the registered covariance matrix, symmetric complex:

$${P}_{n + 1}^{′} = {P}_{n} - K . {PHt}^{*}$$

a sixth step comprising the calculation of the propagated covariance matrix with the forgetting factor, symmetric complex:

$${P}_{n + 1} = {P}_{n + 1}^{′} + 1 / {2}^{n} . {P}_{n + 1}^{′} .$$

It should be noted that if we do not perform the normalization of the complex weights Wₙ₊₁ by C^{t}.X=C^{t}.Rₙ₊₁⁻¹.C then the output signal after linear combination is written:

$$So = {h}_{n + 1} . X = {h}_{n + 1} {R}_{n + 1}^{- 1} . \overline{C} = {h}_{n + 1} . {P}_{n + 1} . \overline{C}$$

To simplify, one can simply calculate:

$$S o = {h}_{n + 1} . {P}_{n} . \overline{C}$$

$$Or :$$

$$So = {PHt}^{*} . \overline{C} = \overline{{PHt}^{t}} . \overline{C}$$

which is equal to the first component of the column vector PHt already calculated during the first step.

According to the invention, each calculation step of the iterative processing is performed by one of the calculation layers of the calculation component 32.

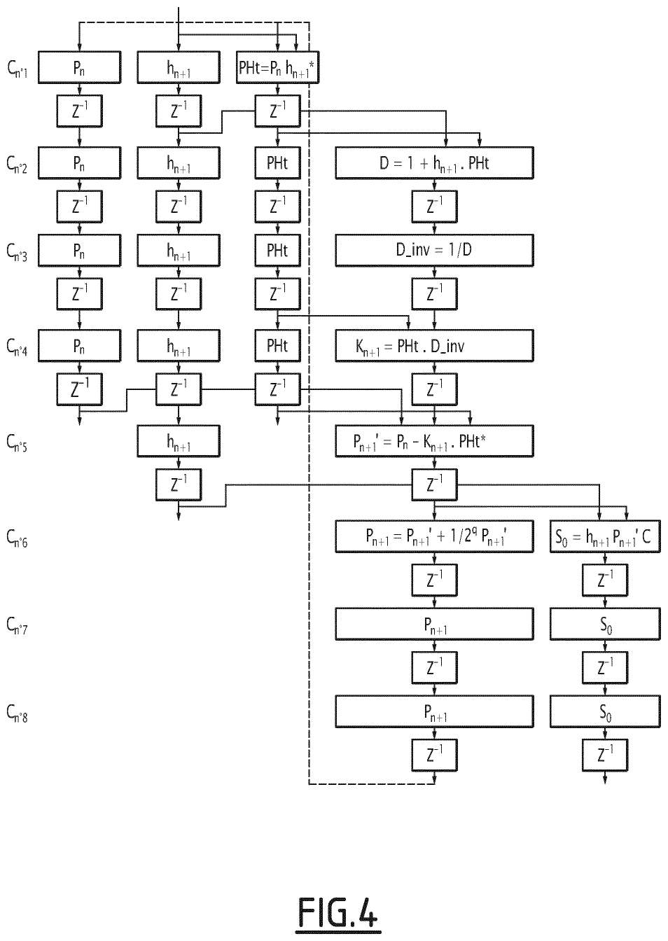

An example of possible implementation of such layers is shown in FIG. 4.

More particularly, in the example of the FIG. 4, the number P is equal to 8, the number B is equal to 1 and the calculation component 32 comprises 8 layers denoted, in FIG. 4, by C number 1 to C number 8. Moreover, in the figure, Pₙ denotes the inverse covariance matrix Rₙ⁻¹ of the cross-correlation matrix Rxx=Rₙ, the vector hₙ denotes the row vector containing the M complex samples of the corresponding sub-sampled signal Sᵢ and the notation X*=X̅^̅{̅t̅}̅ denotes the transposed conjugate vector X.

Referring to FIG. 4:
the layer number 1 is configured to receive the following iterative datum Pₙ, the following sub-sampled signal vector hₙ₊₁ and to calculate the value PHt=Pₙ.hₙ₊₁*;
the layer number 2 is configured to copy the following iterative data Pₙ, the following sub-sampled signal vector hₙ₊₁ and the value PHt, and to calculate the value of D=1+hₙ₊₁.PHt;
the layer number 3 is configured to copy the next iterative data Pₙ, the following sub-sampled signal vector hₙ₊₁, the value PHt and the value D, and to calculate the value D_inv=1/D;
the layer number 4 is configured to copy the following iterative datum Pₙ, the following sub-sampled signal vector hₙ₊₁, the value PHt and the value D_inv, and to calculate the value K=P_{n·h n+1}*. D_inv;
the layer number 5 is configured to copy the sub-sampled signal vector according to hₙ₊₁, the PHt value and to calculate the value Pₙ₊₁′=Pₙ−K.PHt*;
the layer number 6 is configured to calculate a new following iterative datum Pₙ₊₁=P_{n+1′+}½^{q}.Pₙ₊₁′ and the output signal SAPᵢ as hₙ₊₁ Pₙ₊₁′. C, C being the vector C determined beforehand;
the layer number 7 is configured to copy the output signal and the next new iterative datum Pₙ₊₁; and
the layer number 8 is configured to copy the output signal SAPᵢ and the next new iterative datum Pₙ₊₁.

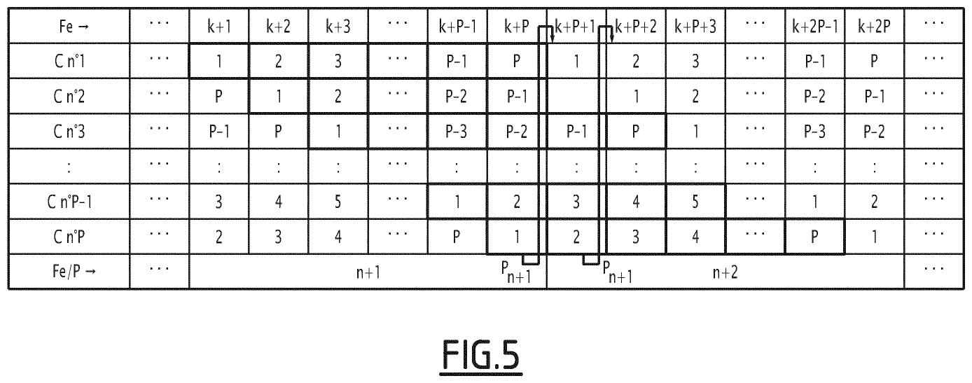

In the present example, the layers number 7 and number 8 are thus pure delay layers intended to supply the new covariance matrix Pₙ₊₁ of sub-band i to layer number 1 when the latter will perform the calculation of the sub-band number i. Thereby, according to FIG. 5 illustrating the generic case of operation of the calculation component 32, in the particular case where the number B of frequency bands is equal to 1, each of the P layers of the calculation component 32 thus processes successively, at the clock frequency Fe, the sub-sampled signals of sub-bands 1 to P produced at each period Fe/P and transmits to the next layer the result of the calculations thereof, in order to enable same to continue processing at the next clock period Fe. The data of each sub-band thus migrate into the P successive layers until a cleaned sub-sampled signal and a propagated re-aligned covariance matrix Pₙ₊₁ are supplied, before restarting a cycle at the next Fe/P period with new sub-sampled input signal samples. In FIG. 5, the indices of the sub-bands processed by each layer, associated with a row of the table, at each period Fe, associated with a column of the table, are represented by the numbers from 1 to P.

Of course, other examples of implementation of the layers of the calculation component 32 are also possible. For example, it is possible to use an architecture with B×P layers for processing B GNSS bands in parallel, by adding (B−1)P pure delay layers, provided that the logic circuit can be operated at the frequency B×Fe. In such a case, each GNSS band is sub-sampled into P sub-bands as explained hereinabove. For example, when B=2, it is possible to add P delay layers, which brings to 2P the total number of layers in the calculation component 32. In such case, when the iterative processing is performed with the calculation example shown in FIG. 4, i.e. by applying 6 pure calculation layers, the total number of delay layers is brought to 2P−6.

The radiofrequency signal processing method implemented by the electronic part 17 will henceforth be explained.

The method is implemented during the operation of the anti-jamming device 10 with the frequency Fe, corresponding to the sampling frequency Fe mentioned hereinabove.

During an initial step, the inputs 21 of the electronic part 17 receive the M elementary signals received by the antenna array 15. The elementary signals are then transmitted to the processing module 22 after digitization, passage to baseband and sampling at the frequency Fe.

During a next step, the filtering component 31 of the processing module 22 receives the elementary signals, brought to baseband and digitized, then decomposes same into P sub-bands and sub-samples the signals at the frequency Fe/P, by means of a bank of digital filters, thereby forming the sub-sampled signals S₁, . . . , S_{P}, as explained hereinabove.

In a next step, the calculation component 32 applies an anti-jamming processing.

Such step comprises in particular the P times implementation of the iterative processing steps explained hereinabove. More particularly, during such steps, each of the layers of the calculation component 32 performs a calculation operation as explained hereinabove.

More particularly, at each clock cycle, the layer number 1 receives a next sub-sampled signal vector along hₙ₊₁ coming from the filtering component 31 and a following iterative datum Pₙ₊₁ coming from the layer number P.

In a following step, the summation component 33 receives the output signal SAP of each sub-band and supplies an output signal of the entire band, cleaned of the jamming.

In a final step, the output 23 thereby receives the cleaned output signal Sn and supplies same to the GNSS receiver 12 after analog conversion and translation into carrier frequency.

In this way, it can be understood that the present invention has a certain number of advantages.

More particularly, it is clear that the decomposition of the input signal into P sub-bands using a bank of digital filters makes it possible to reduce the sampling frequency to Fe/P, in each of the P sub-bands. The above gives more time to carry out all the steps of the calculation of the RLS method and, due to a “pipeline” architecture of the calculation component, to multiplex the operators so as to make the operators common to all the sub-bands. Furthermore, the fact of working in sub-bands increases the rejection performance.

The invention can thus be used for implementing the SFAP technique in a purely hardware way, while making the calculation fast, efficient and inexpensive. The technique can advantageously be combined with the RLS method in order to achieve better performance.

1. An electronic part of a CRPA antenna of an anti-jamming device for a GNSS receiver, comprising:
M inputs receiving elementary signals in B frequency bands from an array antenna comprising M elementary antennas;
for each input and each frequency band, a bandpass filter bank decomposing each elementary signal received by the input in the band at a frequency Fe, into P sub-bands for obtaining P sub-sampled signals at a frequency Fe/P;
a calculation component applying, in each sub-band in parallel, an anti-jamming processing at the frequency Fe/P to the sub-sampled signals coming from said M inputs, so as to obtain a cleaned sub-sampled signal, the calculation component comprising:
a single hardware component for all sub-bands of all bands, operating at the frequency B.Fe; and
B.P calculation layers implementing an iterative processing, each calculation layer operating at the frequency B.Fe and implementing an operation of the iterative processing or a delay operation, the calculation layers being consecutive from a layer number 1 to a layer number B.P; and
a summation component configured to receive all the cleaned sub-sampled signals of the same frequency band and to form from the sub-sampled signals a resulting corresponding cleaned signal, at the frequency.

2. An electronic part according to claim 1, wherein the layer number 1 is apt to receive at each period B.Fe the M sub-sampled signals of the same sub-band and an iterative datum coming from the layer number B.P at the previous period B.Fe.

3. The electronic part according to claim 2, wherein: the iterative processing is the recursive least squares method, and the iterative datum is the symmetric complex covariance matrix Pₙ of dimensions M×M, corresponding to the inverse of the cross-correlation matrix Rₓₓ of the corresponding M sub-sampled signals.

4. The electronic part according to claim 3, wherein the iterative processing comprises:
calculation of the complex vector:
$$PHt = {P}_{n} . {h}_{n + 1}^{*} ,$$
where hₙ₊₁ is the complex line vector containing the M sub-sampled signals from said bandpass filter banks corresponding to the current sampling period;
calculation of the positive real scalar:
$$HPHt = {h}_{n + 1} . PHt ;$$
calculation of the positive real scalar:
$$D\_inv = 1 / ( 1 + HPHt )$$
calculation of the registration gain vector:
K=PHt.D_inv
calculation of the registered covariance matrix, symmetric complex:
$${P}_{n + 1}^{′} = {P}_{n} - K . {PHt}^{*}$$
calculation of the propagated covariance matrix with a forgetting factor, symmetric complex:
$${P}_{n + 1} = {P}_{n + 1}^{′} + 1 / {2}^{n} . {P}_{n + 1}^{′}$$

5. The electronic part according to claim 4, wherein each cleaned sub-sampled signal is one of the components of the corresponding complex vector PHt.

6. The electronic part according to claim 4, wherein each cleaned sub-sampled signal is one of the components of the complex vector Pₙ₊₁. Hₙ₊₁* equal to the product of the propagated covariance matrix Pₙ₊₁ by the conjugate transpose of the complex line vector H.

7. The electronic part according to claim 1, wherein aid bandpass filter banks are produced according to a polyphase filter technique.

8. The electronic part according to claim 1, wherein said summation component comprises an interpolator summing filter adding the cleaned sub-sampled signals.

9. The electronic part according to claim 8, wherein said interpolator summing filter is implemented according to polyphase filter technique.

10. The electronic part according to claim 1, wherein said calculation component comprises an FPGA logic circuit.

11. An anti-jamming device for a GNSS receiver, comprising:
a CRPA (15) antenna; and
an electronic device according to claim 1.

12. A method of signal processing by an electronic part of a CRPA antenna of an anti-jamming device for a GNSS receiver, comprising:
receiving on M inputs of elementary signals in B frequency bands from an array antenna comprising M elementary antennas;
for each input and each frequency band, decomposing by a bank of band-pass filters, each elementary signal received by the input in the band at a frequency Fe, into P sub-bands for obtaining P sub-sampled signals at a frequency Fe/P;
applying, by a calculation component in each sub-band in parallel, an anti-jamming processing at the frequency Fe/P to the sub-sampled signals coming from the M inputs, so as to obtain a cleaned sub-sampled signal, the calculation component comprising:
a single hardware component for all sub-bands of all bands, operating at the frequency B.Fe; and
B.P calculation layers configured to implement an iterative processing, each calculation layer operating at the frequency B.Fe and being apt to implement an operation of the iterative processing or a delay operation, the calculation layers being consecutive from a layer number 1 to a layer number B.P; and
receiving by a summation component all the cleaned sub-sampled signals of the same frequency band and forming from the sub-sampled signals a resulting corresponding cleaned signal, at the frequency.
